(19) United States
(12) Patent Application Publication
(10) Pub. No.: US 2008/0309250 A1
(43) Pub. Date: Dec. 18, 2008

(54) Radio Station and Method of Operating a Radio Station

(75) Inventors: Jos Van Meurs, Eindhoven (NL); Antonio De Almeida Tavares, Schaerbeek (BE); Dennis Johannes Antonius Claessens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 12/097,572

(22) PCT Filed: Dec. 8, 2006
(86) PCT No.: PCT/IB06/54699

§ 371 Date: Jun. 16, 2008

(30) Foreign Application Priority Data
Dec. 22, 2005 (EP) 05112720.7

(51) Int. Cl. H05B 41/36; H05B 41/24

(52) U.S. Cl. 315/276; 315/307

(57) ABSTRACT

A lamp driver circuit supplies an alternating current having an operating frequency to a lamp, e.g. a fluorescent lamp, for operating the lamp. To switch off the lamp, the frequency of the alternating current is changed to a non-operating frequency. Due to the frequency change, the impedance of an impedance element of the lamp driver circuit is changed. As a result, the lamp current decreases to zero and the lamp extinguishes. According to the invention, the current having the non-operating frequency is employed to generate a voltage to be supplied to a further circuit, such as a control circuit. Thus, the lamp driver circuit and an associated control circuit may operate in an operating mode or in a standby, i.e. non-operating, mode without requiring a separate voltage supply source. In the standby mode, the control circuit may be controlled to switch the lamp driver circuit from the non-operating mode into the operating mode, thereby switching the lamp on.

### FIELD OF THE INVENTION

The present invention relates to a lamp driver circuit and a method for operating a lamp using such a lamp driver circuit. In particular, the present invention relates to a lamp driver circuit having a standby mode.

### BACKGROUND OF THE INVENTION

A known electronic lamp driver circuit for driving a fluorescent lamp is designed for use with an ordinary power switch for switching the lamp on or off. When the lamp and the lamp driver circuit are switched off, they are disconnected from the power supply by means of a power-switch and no power is consumed by the lamp and/or the lamp driver circuit.

Digital control of lamps has become available in controlled ballast circuits, i.e. controlled lamp driver circuits, and switching the lamps is performed by means of an electronic control signal. Therefore, the lamp driver circuit is no longer switched off by means of a power switch, but is put in a standby mode. In the standby mode, the lamp driver circuit is waiting for a command to, for example, switch the lamp on or report its status to a controller. In such a standby mode, a small amount of power is needed in order to enable to receive the control signal and to act in response to such a control signal.

In a known ballast circuit having a standby mode, an auxiliary power supply is made with a separate switched-mode power supply integrated with the lamp driver circuit. Such a circuit comprising an auxiliary power supply is an expensive and complex circuit.

### OBJECT OF THE INVENTION

It is an object of the present invention to provide a lamp driver circuit having a standby mode without requiring a separate power supply.

### SUMMARY OF THE INVENTION

In an embodiment of the present invention, there is provided a lamp driver circuit comprising an alternating current supply circuit, the current supply circuit comprising an impedance element and being configured to supply a current having an operating frequency for driving a lamp in an operating state and to supply a current having a standby frequency for driving a lamp in a non-operating state, wherein the lamp driver circuit further comprises a voltage supply circuit operatively coupled to the lamp driver circuit for generating a voltage when the lamp is in the non-operating state.

In the lamp driver according to the present invention, the lamp is operated using an operating frequency of the alternating current supplied to the lamp. To switch the lamp off, another frequency, i.e. a non-operating frequency is used. Due to the other frequency, the impedance of the impedance element, such as an inductance and/or a capacitance, is changed. As a result, the current no longer flows through the lamp, but may flow through a capacitor, or any other element, connected in parallel to the lamp. Consequently, the lamp is extinguished, while a current remains flowing through the capacitor, or the any other element, in parallel to the lamp. The remaining current may advantageously be employed to generate a voltage as a supply voltage to enable the lamp driver circuit to respond to a control input signal.

Auxiliary voltage supplies are known e.g. from a known lamp driver circuit to supply a control circuit and from a lamp driver circuit having dimming capability using a control input. The auxiliary supply is commonly made with the aid of a HF signal derived from the lamp driver. These known lamp driver circuits, however, do not have a standby mode. The same applies, for instance, for an auxiliary power supply to power an integrated circuit in a power factor correction (PFC) circuit commonly applied in lamp drivers.

Further advantages of a power supply employing a signal already available in the lamp driver circuit, such as the alternating current, are a low cost and a relatively small volume and area required.

In an embodiment, the lamp driver circuit comprises a capacitor, which capacitor is also comprised in the voltage supply circuit for generating the voltage. Thus, the voltage supply circuit and the lamp driver circuit are coupled. A person skilled in the art readily understands how a voltage may be generated using a capacitor, through which capacitor an alternating current is flowing.

In an embodiment, the lamp driver circuit comprises an inductance, which inductance is a primary winding of a transformer, where a secondary winding of the transformer is comprised in the voltage supply circuit. The coupling between the primary and secondary winding is used for generating a voltage in the voltage supply circuit in response to the alternating current supplied by the current supply circuit. The voltage supply circuit may further comprise a rectifier circuit connected in series to the secondary winding of the transformer for rectifying the generated voltage.

In an embodiment the secondary winding is a split winding, a center terminal of the split winding being connected to mass and a first end terminal and a second end terminal being connected to the rectifier circuit. Thus, an AC voltage is efficiently converted to a DC voltage.

In an embodiment, the rectifier circuit comprises a first diode connected to the first end of the secondary winding, a second diode connected to the second end terminal of the secondary winding, a DC voltage being generated at a node between the electrical common and an output terminal connected to the first and second diode. Optionally, a capacitor may be connected between the output terminal and the electrical common in order to smooth the generated DC voltage.

In an embodiment, the rectifier circuit is a full-wave rectifier bridge, wherein a first and a second AC terminal of the rectifier bridge are coupled to a first end terminal and a second end terminal of the secondary winding, a first DC terminal of the rectifier bridge being connected to the electrical common, a DC voltage being generated between the electrical common and an output terminal connected to a second DC terminal of the rectifier bridge. Optionally, a capacitor may be connected between the output terminal and the electrical common in order to smooth the generated DC voltage.

In another embodiment, the voltage supply circuit is connected to an output of the lamp driver circuit for receiving the alternating supply current and the voltage supply circuit is configured to convert the alternating supply current into a suitable voltage. A person skilled in the art readily understands how such a voltage supply circuit may be designed and incorporated into a lamp driver circuit.

In an aspect, the present invention further provides a lighting system comprising a lamp driver circuit according to the present invention; a fluorescent lamp coupled to the lamp driver circuit for receiving an alternating current; and a control circuit coupled to the voltage supply circuit of the lamp driver circuit for receiving a supply voltage and coupled to the lamp driver circuit for controlling a frequency of the alternating current supplied to the fluorescent lamp in response to a control input.

In an aspect, the present invention further provides a method of operating a lamp driven by a lamp driver supplying an alternating current to the lamp, the method comprising: supplying by the lamp driver circuit an alternating current having an operating frequency in order to drive the lamp in an operating state; supplying by the lamp driver circuit an alternating current having a standby frequency in order to drive the lamp in a non-operating state; and generating a voltage using the alternating current having a standby frequency when the lamp is in the non-operating state.

### BRIEF DESCRIPTION OF THE DRAWINGS

These and other aspects of the invention are apparent from and will be elucidated with reference to the embodiments described hereinafter.

In the drawings:

FIG. 1 illustrates a prior art lamp driver circuit and fluorescent lamp;

FIG. 2 illustrates an embodiment of a lamp driver circuit and voltage supply circuit according to the present invention;

FIG. 3 illustrates an embodiment of a control circuit for use in the lamp driver circuit of FIG. 2; and

FIG. 4 illustrates an embodiment of a lighting system comprising a lamp driver circuit and a fluorescent lamp controllable when the lamp is switched off in accordance with the present invention.

### DETAILED DESCRIPTION OF EXAMPLES

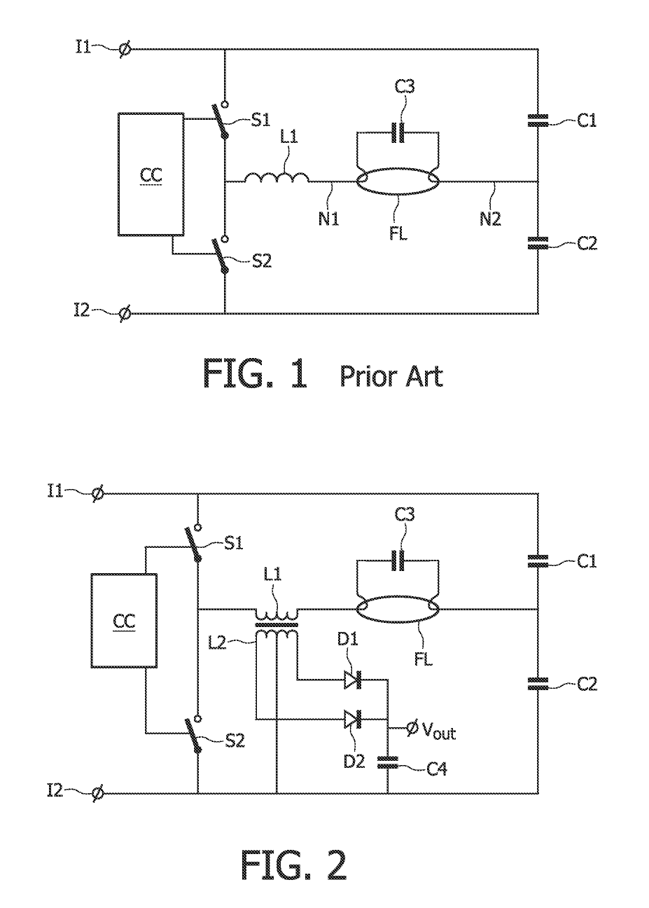

FIG. 1 shows a prior-art lamp driver circuit for operating a fluorescent lamp FL. The lamp driver circuit comprises two input terminals I1, I2 for receiving a DC voltage. A high-frequency inverter circuit comprises switch elements S1, S2, inductor L1 and capacitors C1, C2 and converts the DC voltage into an AC current between circuit nodes N1, N2. Capacitor C3 is used for regulating a heating current for heating the electrodes of the fluorescent lamp FL and is used for igniting the fluorescent lamp FL. A control circuit CC is connected to control terminals of the switches S1, S2.

The operation of the lamp driver circuit of FIG. 1 is well known in the art. The switches S1 and S2 are controlled by the control circuit CC such that the switches S1, S2 are alternatingly switched conductive. There may as well be a period during which neither switch S1, S2 is conductive. Due to the impedance of the inductor L1, the lamp FL and the capacitor C3, a suitable alternating current is generated and supplied to the fluorescent lamp FL. The switching frequency of the switches S1, S2 as controlled by the control circuit CC determines a frequency of the generated alternating supply current. The impedance of the inductor L1, the fluorescent lamp FL and capacitor C3 determine an amount of current that may flow dependent on the frequency.

FIG. 2 shows an embodiment of a lamp driver circuit comprising a voltage supply circuit for generating a voltage when the lamp is in either an operating state or a non-operating state. The basic lamp driver circuit is identical to the lamp driver circuit as shown in FIG. 1, comprising DC voltage input terminals 11, 12, switches S1, S2, first inductor L1, first, second and third capacitors C1, C2, C3, fluorescent lamp FL and control circuit CC. The control circuit CC may not be identical to the control circuit as shown in and described in relation to FIG. 1, as is explained hereinafter.

The voltage supply circuit comprises a second inductor L2, first and second diodes D1 and D2 connected to a respective end terminal of the second inductor L2. The second inductor L2 is a split winding, of which a center terminal is connected to the electrical circuit common or ground. A fourth capacitor C4 is connected between the first and second diodes D1, D2 and the electrical circuit common or ground. Between the fourth capacitor C4 and the first and second diodes D1, D2, an output voltage terminal Vout is provided.

The first inductor L1 and the second inductor L2 are shown as the primary winding and the secondary winding of a transformer, respectively, thereby coupling the first and the second inductor L1, L2. The coupling between the inductors L1, L2 provides that an alternating current is generated in the second inductor L2, when an alternating current flows through the first inductor L1.

The alternating current generated in the second inductor L2 flows depending on the phase of the alternating current from the center terminal to the first end terminal or the second end terminal and then to the first diode D1 or the second diode D2, respectively. The first and second diodes D1, D2 prevent that a current may flow from the fourth capacitor C4 towards the second inductor L2.

The current generated in the second inductor L2 flows to the fourth capacitor C4 and charges the capacitor C4. Thus, a voltage is generated over the fourth capacitor C4. The voltage is applied to the output voltage terminal Vout.

In order to provide a voltage on the output voltage terminal Vout when the lamp FL is off, the lamp FL is switched off by changing the frequency of the alternating current such that the amount of current through the lamp FL decreases to zero. The remaining current through capacitor C3 is suitable for supplying a desired voltage at the output voltage terminal. The control circuit CC is configured to control the frequency. Therefore, the control circuit CC of FIG. 2 is configured to control the switches S1, S2 at least two different frequencies: an operating frequency and a non-operating frequency. By contrast, in the prior-art lamp driver circuit of FIG. 1 the control circuit may be configured to control the switches at only one predetermined frequency.

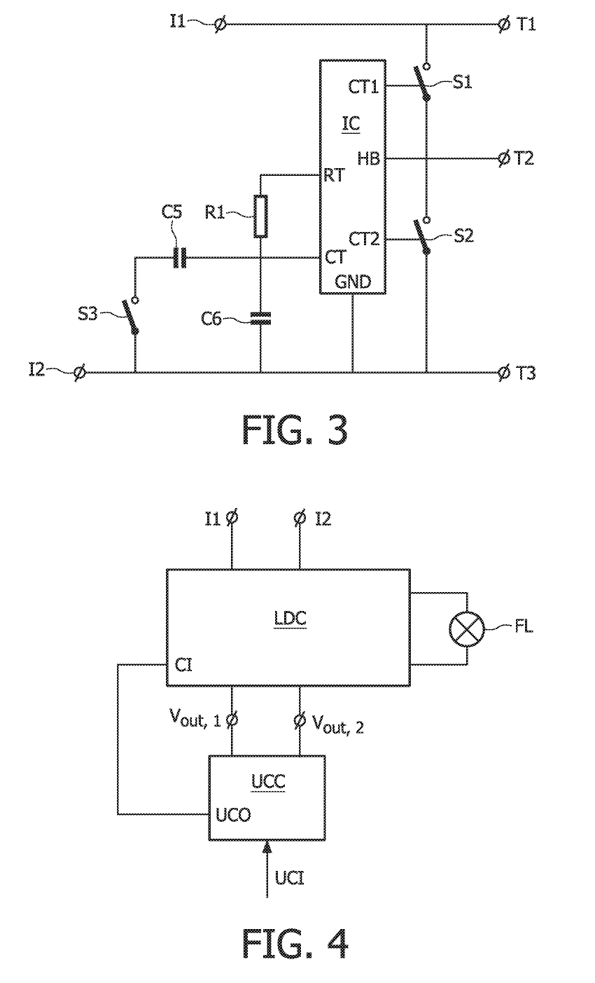

FIG. 3 shows an embodiment of a suitable control circuit connected to switches S1, S2 for use in the lamp driver circuit as shown in FIG. 2. The control circuit comprises a prior-art integrated circuit IC commonly used in such a lamp driver circuit. The integrated circuit IC comprises two control terminals CT1, CT2 connected to the control terminals of the switches S1, S2, respectively. A half-bridge voltage terminal HB and an electrical common or mass terminal GND are connected to respective circuit nodes. A resistance terminal RT and a capacitance terminal CT are connected to an RC-circuit comprising a resistor R1 and a sixth capacitor C6. The terminals T1, T2, T3 may be connected to further circuit elements as shown in FIG. 2.

The impedance characteristics of the RC-circuit (R1, C6) determine the switching frequency applied to the switches S1, S2. To provide a second switching frequency, a third switch S3 in series with a fifth capacitor C5 is connected in parallel to the sixth capacitor C6. The third switch S3 may be manually controllable or electronically controllable. The third switch S3 may be a suitable transistor, for example.

When the switch S3 is conductive, the fifth and the sixth capacitors C5, C6 are connected in parallel, thus providing a large capacitance compared to only the sixth capacitor C6. Therefore, if switch S3 is non-conductive, the switching frequency of the switches S1, S2 is equal to the non-operating frequency, thus the lamp is extinguished. If the switch S3 is conductive, the switching frequency of the switches S1, S2 is equal to the operating frequency, thus the lamp is on. Thus, the third switch S3 may be employed to switch the lamp FL on or off.

FIG. 4 shows a schematic diagram illustrating a user-controllable fluorescent lamp Fl in accordance with the present invention. A lamp driver circuit LDC, of the type as shown in FIG. 3, is connected to the fluorescent lamp FL for supplying an alternating current to the lamp FL. The lamp driver circuit LDC comprises a voltage supply circuit for supplying a suitable voltage via output voltage terminals Vout,1 and Vout,2 to a user control circuit UCC. The user control circuit UCC comprises a user control input terminal UCI and a user control output UCO connected to a control input CI of the lamp driver circuit LDC. The control input CI of the lamp driver circuit LDC controls the state of the third switch (FIG. 3, S3, electronically controllable (not shown)) and thus the operating state of the fluorescent lamp FL. A suitable supply voltage is supplied to the input terminals I1, I2.

In an operating state, an alternating current having an operating frequency is supplied to the lamp FL. A suitable voltage is supplied to the user control circuit UCC, which controls the lamp driver circuit LDC to supply the alternating current at the operating frequency.

In response to a user input through the user control input terminal UCI, the user control circuit UCC controls the lamp driver circuit LDC to change, e.g. increase, the operating frequency to a suitable predetermined non-operating frequency, thereby switching off the lamp FL. The voltage supply to the user control circuit UCC is maintained due to the remaining alternating current. Thus, although the fluorescent lamp FL is switched off, the lamp driver circuit LDC remains on in order to provide the user control circuit UCC with a required suitable voltage.

The user control input terminal UCI may be any kind of input terminal. For example, the input terminal may be a wireless communication (radio-frequent, infrared, and the like) input terminal or a wired terminal. There may as well be a bidirectional communication with a user control device communicating with the user control circuit UCC.

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily wiredly.

1. Lamp driver circuit comprising an alternating-current supply circuit, the current supply circuit comprising an impedance element and being configured to supply a current having an operating frequency for driving a lamp in an operating state and to supply a current having a non-operating frequency for driving a lamp in a non-operating state, wherein the lamp driver circuit further comprises a voltage supply circuit operatively coupled to the lamp driver circuit for generating a voltage when the lamp is in the non-operating state.

2. Lamp driver circuit according to claim 1, wherein the lamp driver circuit is configured to drive a fluorescent lamp.

3. Lamp driver circuit according to claim 1, wherein the lamp driver circuit comprises a capacitor, the capacitor being comprised in the voltage supply circuit for generating the voltage.

4. Lamp driver circuit according to claim 1, wherein the lamp driver circuit comprises an inductance, which inductance is a primary winding of a transformer, a secondary winding of the transformer being comprised in the voltage supply circuit for generating a voltage in the voltage supply circuit in response to the alternating current supplied by the current supply circuit.

5. Lamp driver circuit according to claim 4, wherein the voltage supply circuit further comprises a rectifier circuit connected in series to the secondary winding of the transformer for rectifying the generated alternating voltage.

6. Lamp driver circuit according to claim 5, wherein the secondary winding is a split winding, a center terminal of the split winding being connected to electrical common and a first end terminal and a second end terminal being connected to the rectifier circuit.

7. Lamp driver circuit according to claim 6, wherein the rectifier circuit comprises a first diode connected to the first end of the secondary winding, a second diode connected to the second end terminal of the secondary winding, a DC voltage being generated at a node between the electrical common and an output terminal connected to the first and second diode.

8. Lamp driver circuit according to claim 5, wherein the rectifier circuit is a full-wave rectifier bridge, wherein a first and a second AC terminal of the rectifier bridge are coupled to a first end terminal and a second end terminal of the secondary winding, a first DC terminal of the rectifier bridge being connected to the electrical common, a DC voltage being generated between a second DC terminal of the rectifier bridge and the electrical common.

9. Lamp driver circuit according to claim 1, wherein the non-operating frequency is higher than the operating frequency.

10. Lighting system comprising:
a lamp driver circuit according to claim 1;
a fluorescent lamp coupled to the lamp driver circuit for receiving an alternating current; and
a control circuit coupled to the voltage supply circuit of the lamp driver circuit for receiving a supply voltage and coupled to the lamp driver circuit for controlling a frequency of the alternating current supplied to the fluorescent lamp in response to a control input.

11. Method of operating a lamp driven by a lamp driver circuit supplying an alternating current to the lamp, the method comprising:
supplying by the lamp driver circuit an alternating current having an operating frequency in order to drive the lamp in an operating state;
supplying by the lamp driver circuit an alternating current having a standby frequency in order to drive the lamp in a non-operating state; and
generating a voltage using the alternating current having a standby frequency when the lamp is in the non-operating state.
